(19) United States
(12) Patent Application Publication
(10) Pub. No.: US 2011/0047843 A1
(43) Pub. Date: Mar. 3, 2011

(54) Removable Shoelace Attachment for Laced Shoelaces

(76) Inventors: Patrick Russo, (US); Nicholas A. Scerbo, Rutherford, NJ (US); Suraj Kaufman, Jersey City, NJ (US)

(21) Appl. No.: 12/551,670

(22) Filed: Sep. 1, 2009

(51) Int. Cl. G09F 23/00

(52) U.S. Cl. 40/636

(57) ABSTRACT

The technology disclosed herein provides a device that is a shoelace attachment which exhibits removable indicia and is comprised of a unitary upper and a lower portion that non-permanently engage to one another forming a portal adapted for passage of a shoelace. The shoelace attachment further comprises recesses on the upper portion and protrusions on a display base, where the protrusions are adapted for removable engagement with the recesses and the display base exhibits indicia, so that the shoelace attachment exhibits indicia on a laced shoelace without the requirement of unlacing.

### FIELD OF THE DISCLOSED TECHNOLOGY

The disclosed technology relates generally to shoelace attachments, and more specifically, to shoelace attachments for the purpose of displaying indicia.

### BACKGROUND OF THE DISCLOSED TECHNOLOGY

In the case of athletic-type footwear, sometimes referred to as “sneakers,” it is well known that visibly distinctive emblems, insignia or trademarks may be attached to the shoe by the manufacturer. It is also known that decorative attachments can be added to the sneakers by the user, such attachments generally being associated with the laces of the shoe. Exemplary disclosure of such decorative attachments are found in the following prior art.

U.S. Pat. No. 4,932,914 to Aranda discloses a clip attachment which is placed over a plurality of sections of a tied shoelace, the clip further comprising a decorative design without being securely fastened onto a shoelace. Without being securely fastened, the attachment may fall off a shoe while in use, and may never be found or recovered.

U.S. Pat. No. 6,477,754 to Alexander discloses an attachment for a shoelace which is fastened to the shoelace by way of lacing through the attachment. The threading of a shoelace through a device necessitates an inconvenient and time-consuming process of lacing and unlacing the shoelace in order to add or remove the attachment. Such a process also results in a wearing down of the ends/mid-region of a shoelace and the eyelets of the shoe.

There is a need in the art to provide a decorative attachment for shoelaces that is convenient and quick to put on and take off, but stays securely attached to the midsection of a shoelace.

### SUMMARY OF THE DISCLOSED TECHNOLOGY

It is therefore an object of the disclosed technology to provide an attachment for shoelaces that is decorative, easy to put on and take off, and stays securely affixed to the shoelace.

It is a further object of the disclosed technology to provide a shoelace attachment that forms a nonpermanent engagement with a laced shoelace without having to unlace the shoelace itself.

Embodiments of the disclosed technology provide a shoelace attachment comprising an upper and a lower portion. The upper and lower portions form a unitary structure due to their connection on one side thereof. The lower portion is adapted for placement under a tied (laced) shoelace on a shoe, whereas the upper portion is adapted for placement above the shoelace. A side of each of the upper and lower portions, opposite the connecting side described above, is adapted for non-permanent engagement with the respective other portion. When the upper and lower sides are engaged, the shoelace attachment forms a generally flat, elongated portal that is slightly wider than a shoelace placed therein (e.g., wide enough to fit over a shoelace and remain in a fixed orientation relative to the shoelace during regular usage thereof).

In an embodiment of the disclosed technology, a shoelace attachment is removably attached (can be removed without the untying of the shoelace) to a shoelace that is tied on a shoe. The shoelace attachment is removable from the shoelace by disengaging the upper and lower portions of the non-permanently engaged side.

Further embodiments of the disclosed technology comprise a portal adapted for the passage of a shoelace. In embodiments disclosed herein, the portal of the shoelace has internal frictional ridges that prevent the shoelace attachment from sliding along the shoelace.

An embodiment of the disclosed technology utilizes a plurality (e.g., two or more) of recesses on the upper portion. A display base, which exhibits indicia (e.g., a design, symbol, character, or an aesthetic feature), has a corresponding plurality of (e.g., two) protrusions adapted for nonpermanent engagement with the recesses of the upper portion. Thus, a display base may be attached and removed from the upper portion of the shoelace attachment in this embodiment.

A further embodiment of the disclosed technology provides a method of attaching indicia to a shoelace. A removably attached display base may be attached to a shoelace, where the display base has protrusions adapted for removable engagement to recesses on the shoelace attachment. A shoelace may then be placed in a portal formed between an upper and lower portion of the shoelace attachment, where the upper and lower portion of the shoelace attachment are permanently attached to each other on one side, forming a unitary structure. Attaching the non-permanently attached sides of the upper and lower portions of the shoelace attachment creates a portal adapted for the passage of the shoelace. The method may further involve removing the shoelace attachment by disengaging the upper and lower portions of the non-permanently connecting side, allowing the shoelace to be removed.

A further embodiment of the disclosed technology provides a base for a shoelace attachment, the base having viewable indicia and at least two recesses. The shoelace attachment may have two or a plurality of protrusions adapted for removable engagement with the recesses, allowing the base and the shoelace attachment to be removably attached. An upper and lower portion of the shoelace clip may have one side forming a permanent unitary structure, and the other sides adapted to connect in a non-permanent manner.

### BRIEF DESCRIPTION OF THE DRAWINGS

FIG. 1 shows a top perspective view of a shoelace attachment and shoelace in an embodiment of the disclosed technology.

FIG. 2A is a cross-sectional view of FIG. 1 along the A-A axis in a closed configuration.

FIG. 2B is a cross-sectional view of FIG. 1 along the A-A axis, in an open configuration.

FIG. 3 is a cross-sectional view of FIG. 1 along the B-B axis.

FIG. 4A shows a bottom perspective view of a display base, in an embodiment of the disclosed technology.

FIG. 4B shows a side view of a display base, in an embodiment of the disclosed technology.

FIG. 5 shows a top perspective view of a shoelace attachment and an interlocking display base positioned for attachment there-between in an embodiment of the disclosed technology.

### DETAILED DESCRIPTION OF EMBODIMENTS OF THE DISCLOSED TECHNOLOGY

Embodiments of the disclosed technology comprise a shoelace attachment with a portal formed therein for attachment around a shoelace already laced in a shoe.

Embodiments of the disclosed technology further comprise a shoelace attachment device for display of indicia, designed for attachment to the shoelace between a first pair (closest to the toe space of the shoe) of eyelets (e.g., rings, holes, loops or lugs adapted for securing laces) or a consecutively laced pair of eyelets of a shoe. Such a shoelace attachment has an upper and lower portion, where the first parts of the adjacent sides of each of the upper portion and lower portion form a unitary structure (are connected permanently). An embodiment further is comprised of a side opposite the adjacent side of each of the upper and lower portions adapted for non-permanent engagement to the respective other portion at a second part thereof. When the opposing sides are engaged, a generally flat, elongated portal between the upper and lower portions is formed, where a width of the portal is slightly wider than a shoelace. Further, when engaged, the orientation of the shoelace attachment and the shoe itself and/or the part of the lace on which the device is attached, remains constant. Thus, the attachment remains in place on the shoe during normal usage thereof. A display base that displays indicia may be removably attached to embodiments of the shoelace attachment. The shoelace attachment is removable from the shoelace by disengaging the upper and lower portions at the second parts.

The disclosed technology will become clearer in light of the description of the figures below.

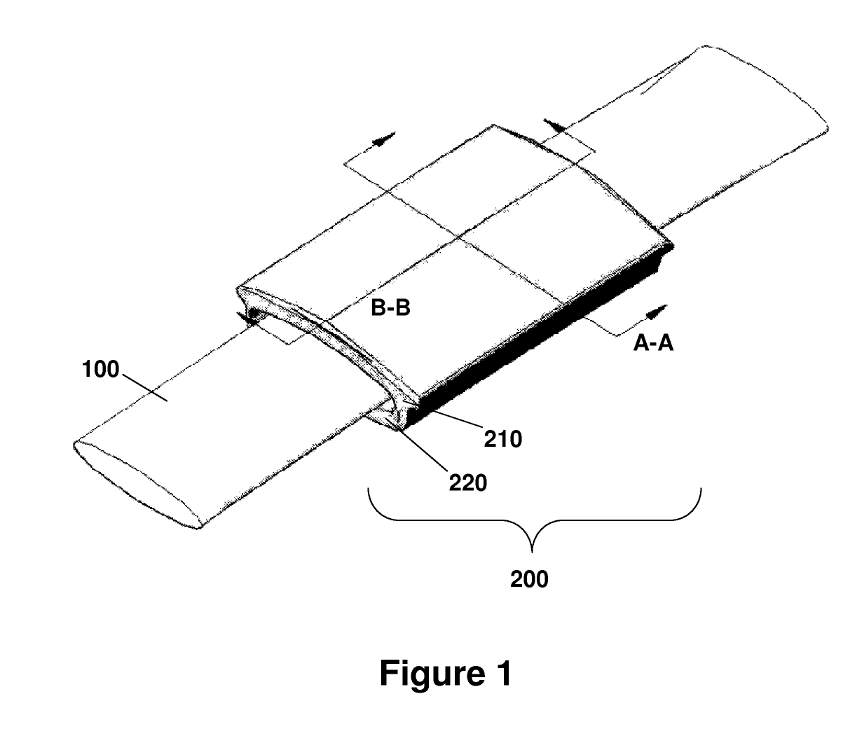

FIG. 1 shows a top perspective view of a shoelace attachment and shoelace in an embodiment of the disclosed technology. In the device shown, the shoelace attachment 200 is attached (positioned around and clasped such that the orientation of the shoelace within the attachment cannot change) to a non-knotted portion of the shoelace 100. The shoelace attachment 200 may be removably engaged to a shoelace at any non-knotted, continuous portion of a shoelace, such as around a portion of a shoelace extending between two eyelets of a shoe, for instance at the lowermost portion thereof.

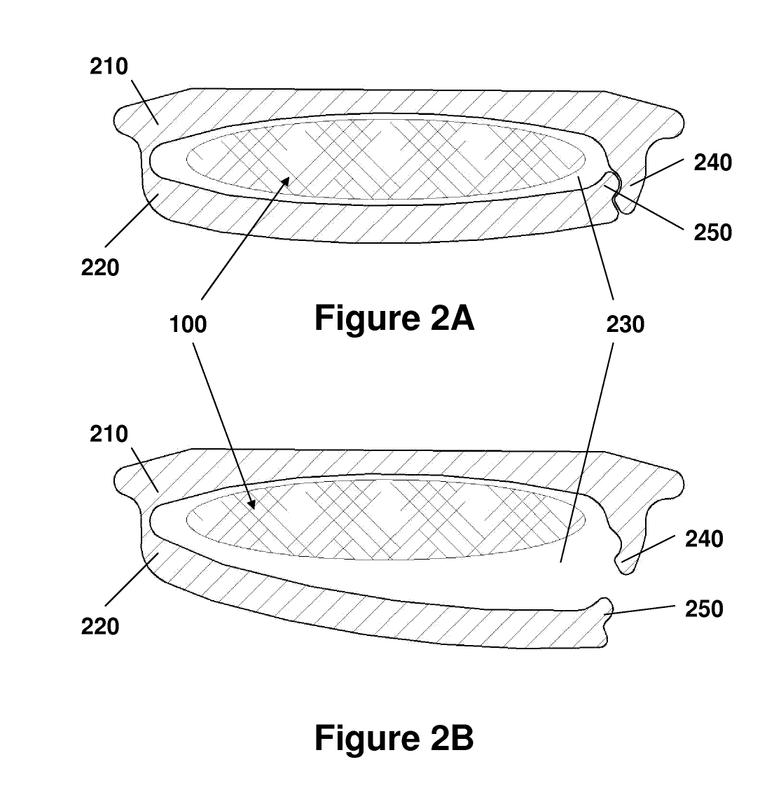

FIG. 2A is a cross-sectional view of FIG. 1 along the A-A axis in a closed configuration. FIG. 2B is a cross-sectional view of FIG. 1 along the A-A axis, in an open configuration. As can be seen in FIG. 1, as well as FIGS. 2A and 2B, the shoelace attachment 200 comprises an upper portion 210 and a lower portion 220. In further embodiments, when the shoelace attachment is affixed to a shoelace tied to a shoe, the lower portion 220 of the shoelace attachment is positioned between the shoelace and the body of the shoe. The upper portion 210, is positioned opposite the lower portion and above the shoelace, positioning the shoelace between the upper and lower portions.

In further embodiments, an adjacent side of the upper portion 210 and lower portion 220 are permanently connected, forming a unitary structure. In embodiments disclosed, the permanent connection between the upper and lower portions is adapted for the upper and lower portions to have an angle of rotation along their respective adjacent sides (e.g., the permanent connection is a hinge, flexible material, or the like). The sides of the upper and lower portions opposite their respective adjacent sides (the non-permanently connected sides) are adapted for non-permanent engagement with each other.

Relative to a shoe, the upper portion 210 is positioned above a shoelace 100, and the lower portion 220 is positioned under the shoelace 100. In an embodiment of the disclosed technology, a hold 240 (also referred to as an upper hold) on a side opposite the adjacent side of the upper portion and an opposing hold 250 (also referred to as a lower hold) is located on a side opposite the adjacent side of the lower portion. The top hold is adapted for non-permanent engagement with the bottom hold, and vice versa. Non-permanent engagement for the upper hold and the lower hold is defined as remaining engaged under normal usage of the device, e.g., worn on a portion of a shoelace extending between the first (lower-most) pair of eyelets in a shoe, and disconnecting under a proper application of force (e.g., pulling or pushing in a specified area, removing a latch, unhooking, etc.)

In an embodiment of the disclosed technology, as displayed in the example in FIG. 2B, when the upper hold 240 and the lower hold 250 are engaged, the shoelace attachment comprises a generally flat, elongated portal 230 (which is adapted for the passage of a shoelace) between the upper portion 210 and the lower portion 220. The portal 230 is adapted for the passage of the shoelace 100 and is slightly wider than a shoelace, where slightly wider is defined as within 1, 5, 10, or 20 millimeters wider than a taut shoelace's respective circumferential dimensions, and/or such that a generally horizontal orientation of a shoelace through the portal defined between upper portion 210 and lower portion 220 is maintained during ordinary usage of the device and/or while the device remains in a latched configuration (e.g. removably engaged with a shoelace).

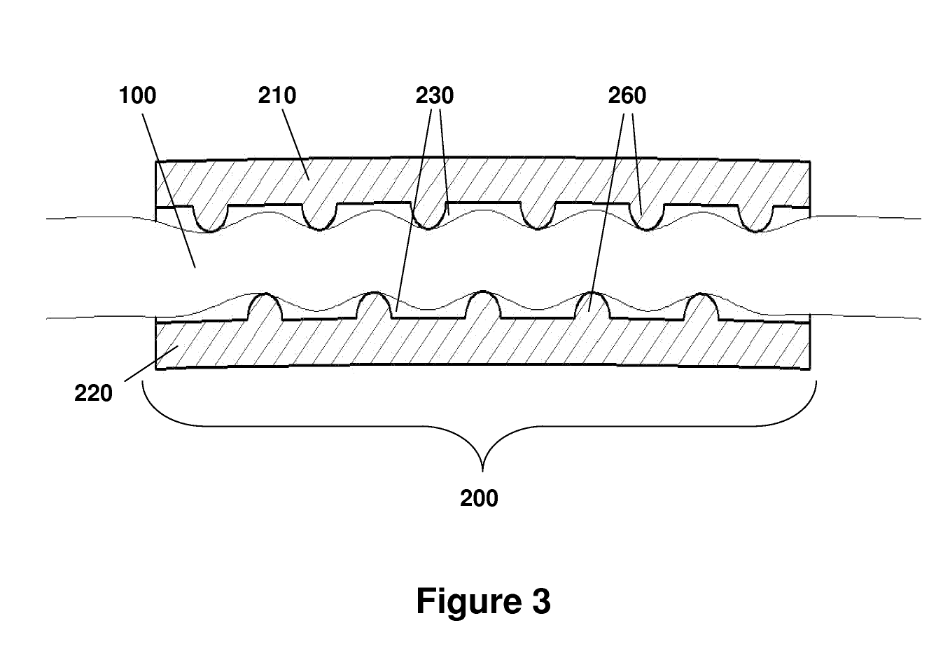

FIG. 3 is a cross-sectional view of FIG. 1 along the B-B axis. A shoelace 100 is shown in the portal 230 formed between the upper portion 210 and a lower portion 220 of the shoelace attachment 200.

In an embodiment of the disclosed technology, the portal 230 comprises internal frictional ridges 260. When a wearer of a shoelace attachment removably engages the shoelace attachment 200 with the shoelace 100, the internal frictional ridges 260 reduce lateral movement of the shoelace attachment 200 relative to the shoelace 100. In an embodiment disclosed, internal frictional ridges are comprised of either a plurality of ridges (e.g., bumps, hooks, serrated edges, etc.), a material that has a higher coefficient of friction with a shoelace than a material comprising the upper and lower portions, or a combination thereof.

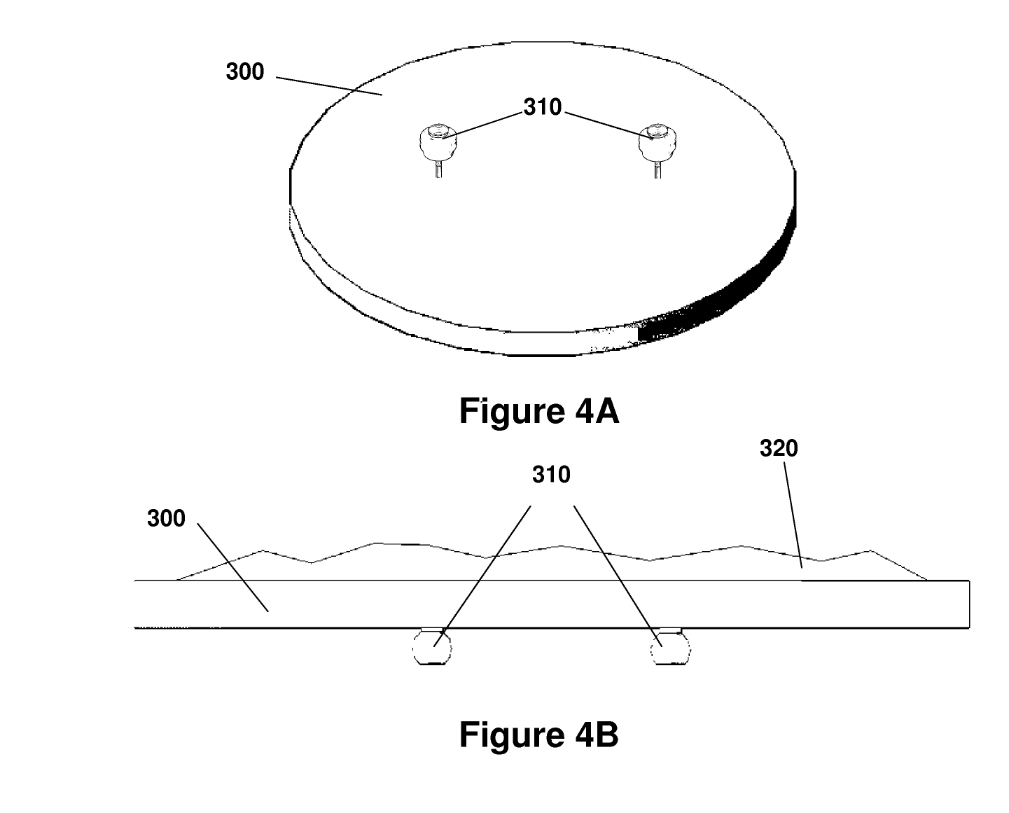

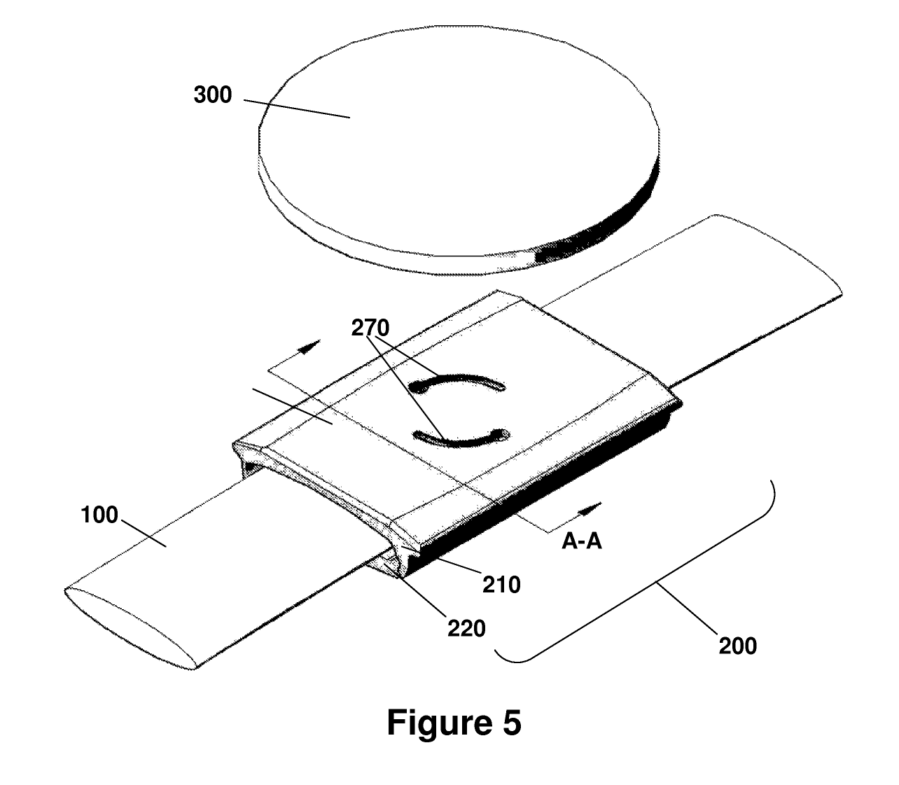

FIG. 4A shows a bottom perspective view of a display base, in an embodiment of the disclosed technology. FIG. 4B shows a side view of a display base, in an embodiment of the disclosed technology. The display base 300 comprises at least two protrusions 310 adapted for removable engagement with at least two recesses on the upper portion 210. The recesses and protrusions are described in further detail in the example displayed in FIG. 5.

In an embodiment of the disclosed technology, the display base comprises viewable indicia 320. Examples of viewable indicia include, but are not limited to, logos, designs, pictures, images, light displays, sound generators, information, and the like which may be two- or three-dimensional. Furthermore, since the display base is removable from the upper portion 210, a wearer of shoelaces may exhibit multiple indicia while only being in possession of a single shoelace attachment 200. Yet further, a wearer may exhibit multiple indicia on a shoelace attachment 200 without having to remove the attached device from the shoelace.

For an illustrative example, a boy with one shoelace attachment 200 attached to his shoelace 100, is further in possession of an indicium comprising a picture of a basketball and an indicium comprising a picture of a baseball. In the morning, he attaches the shoelace attachment to his shoe by placing the upper and lower portions thereof around his shoelace, such that the shoelace extends through the portal formed between the portions. The part of the shoelace on which the device is attached is the piece of shoelace between a first pair of eyelets of his shoe. He exhibits the basketball indicium on his shoelace attachment while playing basketball. When the boy plays baseball, he then replaces the basketball indicium with the baseball indicium without having to remove the shoelace attachment 200 from the shoelace or having to purchase a second shoelace attachment.

FIG. 5 shows a top perspective view of a shoelace attachment and an interlocking display base positioned for attachment there-between in an embodiment of the disclosed technology. A base 300 for shoelace attachment comprising a shoelace attachment 200 that is adapted for non-permanent engagement and disengagement with a shoelace 100 (between a first, lowest pair of eyelets of a shoe) while a shoelace is laced on a shoe (shoe is not shown). The shoelace attachment comprises an upper and a lower portion 210-220 which further comprises an adjacent side of each of the upper and lower portions forming a unitary structure there-between.

In an embodiment of the disclosed technology, the upper portion 210 of the shoelace attachment comprises at least two recesses 270. Recesses 270 are internal and/or external components adapted for removable engagement with at least two protrusions 310 of the display base. A display base 300 for a shoelace attachment 200 comprises viewable indicia and at least two recesses 270. The shoelace attachment 200 comprises at least two protrusions adapted for removable engagement with said at least two recesses.

A method for attaching indicia to a shoelace, with reference to the device displayed in FIGS. 1-5, comprises removably attaching a display base 300. The display base further comprises viewable indicia 320 and at least two protrusions 310 adapted for removable engagement with recesses 270 of a shoelace attachment 200. The shoelace 100 is placed in a portal 230 formed between an upper and lower portion 210-220 of the shoelace attachment, wherein a first part of an adjacent side of each of the upper and lower portion forms a unitary structure. The method further comprises removably attaching a second part of each of the upper and lower portions to one another (as displayed in the difference between FIG. 2A and FIG. 2B) so as to removably engage the shoelace attachment 200 with a shoelace 100 in a portal 230 adapted for passage of the shoelace (e.g., a portion of the shoelace between the lowest set of eyelets of the shoe). After attachment, the shoelace exhibits indicia favorable to a wearer of the shoelace.

Removal of the indicia 320 from a shoelace 100 comprises of disengaging the upper 210, and lower 220, portions of the shoelace attachment 200 and removing the shoelace attachment from the shoe. Another method of indicia removal from the shoelace attachment comprises disengaging the recesses 270 and protrusions 310 of the upper portion 210 and the display base 300.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

We claim:

1. A shoelace attachment comprising:
an upper and lower portion thereof, wherein a first part of an adjacent side of each of said upper portion and lower portion forms a unitary structure;
a side opposite said adjacent side of each said upper and lower portion adapted for non-permanent engagement to said respective other portion at a second part thereof; and
when engaged, a generally flat, elongated portal between said upper and lower portions, wherein a width of said portal is slightly wider than a shoelace.

2. The shoelace attachment of claim 1, wherein said shoelace attachment is removably engaged with a shoelace on a shoe.

3. The shoelace attachment of claim 2, wherein said attachment is removable from said shoelace by disengaging said upper and lower portions at said second part.

4. The shoelace attachment of claim 1, wherein said portal is adapted for passage of a shoelace therein.

5. The shoelace attachment of claim 4, wherein said portal comprises internal frictional ridges.

6. The shoelace attachment of claim 3, wherein said upper portion of said shoelace attachment comprises at least two recesses.

7. The shoelace attachment of claim 3, wherein a display base comprises at least two protrusions adapted for removable engagement with said at least two recesses.

8. The shoelace attachment of claim 7, wherein said display base comprises viewable indicia.

9. A method for attaching indicia to a shoelace comprising:
removably attaching a display base comprising visible indicia and at least two protrusions adapted for removable engagement with recesses of a shoelace attachment to said shoelace attachment;
placing a shoelace in a portal formed between an upper and lower portion of said shoelace attachment, wherein a first part of an adjacent side of each of said upper and lower portion form a unitary structure; and
removably attaching a second side of each of said upper and lower portion to each other.

10. The method of claim 9 comprising removably engaging said shoelace attachment with a shoelace.

11. The method of claim 9 comprising removing attachment from said shoelace by disengaging said upper and lower portions at said second part.

12. The method of claim 9 comprising passing the shoelace through a portal adapted for passage of said shoelace.

13. The method of claim 9, wherein said shoelace is a portion of said shoelace between a lowest pair of eyelets of said shoe.

14. A base for a shoelace attachment comprising:
visible indicia; and
at least two protrusions adapted for engagement with corresponding recesses of said shoelace attachment;
wherein said shoelace attachment is adapted for non-permanent engagement and disengagement with a shoelace while said shoelace is laced on a shoe.

15. The base of claim 14, wherein said shoelace attachment is engaged on a shoelace between a first, lowest pair of eyelets of a shoe.

16. The base claim 14, wherein said shoelace attachment comprises at least two protrusions adapted for removable engagement with said at least two recesses.

17. The base of claim 14, wherein said shoelace attachment comprises an upper and a lower portion, which further comprise an adjacent side of each of said upper portion and lower portions forming a unitary structure there-between.

18. The base for a shoelace attachment of claim 17, wherein said upper portion comprises said at least two protrusions.

19. The base for a shoelace attachment of claim 17, wherein said shoelace attachment comprises a side opposite said adjacent side of each said upper and lower portion adapted for non-permanent engagement to said respective other portion at a second part thereof.
